(19) United States
(12) Patent Application Publication
(10) Pub. No.: US 2008/0302247 A1
(43) Pub. Date: Dec. 11, 2008

(54) ULTRA-VIOLET VENTILATION SYSTEM HAVING AN IMPROVED FILTERING DEVICE

(75) Inventors: Erik MAGNER, Oakville (CA); Chester RACZEWSKI, Mississauga (CA); Joe PROFENDA, Toronto (CA)

Correspondence Address: MILES & STOCKBRIDGE PC, 1751 PINNACLE DRIVE, SUITE 500, MCLEAN, VA, 22102-3833, US

(73) Assignee: OY HALTON GROUP LIMITED

(21) Appl. No.: 12/137,471

(22) Filed: Jun. 11, 2008

Related U.S. Application Data
(62) Division of application No. 11/069,844, filed on Mar. 1, 2005, now abandoned.
(60) Provisional application No. 60/548,878, filed on Mar. 2, 2004.

(51) Int. Cl. B01D 35/00; B01D 36/02

(52) U.S. Cl. 96/224; 55/482; 55/429

(57) ABSTRACT

An air ventilation system, comprising an air inlet for admitting contaminated air into the ventilation system, an air outlet for discharging decontaminated air from the ventilation, and an ultra-violet light source disposed therebetween. The ventilation system has a filter disposed upstream of the ultra-violet light source. The filter has a grease particle separator with at least two layers of expanded metal associated therewith. Each has a predetermined number of apertures forming a reticulum. A cartridge filter may be provided for each grease particle separator and disposed upstream thereof. Each cartridge filter and associated grease particle separator preferably forms an integral filtering unit and may be placed at any location of the system.

### CROSS REFERENCE TO RELATED PATENT APPLICATIONS

The instant application claims priority to U.S. Provisional Patent Application No. 60/548,878 filed on Mar. 2, 2004 which is herein incorporated by reference in its entirety.

### FIELD OF THE INVENTION

The present invention relates to an air ventilation system for use with a cooking appliance. More particularly, the present invention relates to an improved ventilation system having an ultra-violet light source and an improved filter at an air inlet for treating a contaminated air stream.

### BACKGROUND OF THE INVENTION

Ventilation systems are well known in the art for removing contaminated air produced by a cooking appliance. The contaminated air has contaminants disposed therein, such as smoke, grease, odor, particles and other unwanted gaseous substances. Grease laden air has proven to be especially problematic in commercial cooking establishments.

Although grease laden air emitted from a cooking source usually travels up along a ventilation duct disposed at a certain distance above the cooking source, some of the grease laden air may collect on the ventilation duct, hood or other areas of the ventilation system in the form of grease deposits that may create a dangerous fire hazard. These grease deposits can pose a fire hazard and local law and ordinances require frequent cleaning for the removal of the same.

Once the grease is cooled the cooled grease may accumulate and/or back flow down the food to, for example, the floor, in the duct or collect behind a stove. This back flow creates a risk of fire hazard. Given the transient nature of the employees employed in the hospitality and commercial cooking establishments, the collected grease may without knowing accumulate on a wall, duct or floor. This accumulation of cooking grease may result in a number of detrimental aspects to an overall productivity of amenity of the food establishment.

These detrimental aspects may include the fact that grease accumulation attracts bacteria, dirt, pests, rodents and viruses and results in unsanitary conditions. The grease accumulation may also lead to repelling odor that has negative effects on overall dining experience of customers, and the health of workers.

In a normally operating food establishment, hot grease laden air continuously flows through a ventilation system. The ventilation system also operates at a high temperature environment. Thus, any accumulation of grease in ventilation system may also create a fire hazard if neglected and not cleaned. One attempt in the art has been the use of ultra-violet (UV) light to decontaminate air in ventilation systems.

Ultra-violet wavelengths commonly used for purification are 185 nano-meters (nm) and 254 nm. Ultra-violet based air purification devices generally includes an ultra-violet light source located within a quartz tube or sleeve that is disposed in a ventilation duct or hood. The ventilation duct has an inlet for receiving a contaminated grease laden air stream and an outlet. The outlet is for discharging the contaminated air stream to ambient. Contaminated air stream is passed through a chamber over the quartz sleeve. Ultra-violet lights operating at a suitable predetermined wavelength, such as around 185 nm produce ozone in the contaminated air stream and thus oxidizes effluents, grease, oil, volatile organic compounds and germs in the air stream.

In order to enhance air purifying function, a filter may be disposed adjacent the inlet of the ventilation duct. The filter filters out particles and captures grease before treatment with the ultra-violet light source. Such filters are typically made from a mesh. When grease and oil droplets are captured in or on the filter, the grease and oil tend to be retained thereon. This creates potential risks of a fire hazard.

Therefore, there is a need for an improved ventilation system that reduces a fire hazard.

There is also a need for a ventilation system that can be easily cleaned and reduces maintenance time.

There is also a need for a ventilation system that reduces cleaning costs and labor costs associated with cleaning the ventilation duct and hood by modulating a grease laden air stream's flow to remove grease from the grease laden air stream.

### SUMMARY OF THE INVENTION

In accordance with one aspect of the present invention, there is provided an air ventilation system having an air inlet for admitting contaminated air into the ventilation system, an air outlet for discharging decontaminated air from the ventilation, an ultra-violet light source disposed therebetween. The ventilation system further comprises a filtering means disposed upstream of the ultra-violet light source. The filtering means has at least one grease particle separator with at least two layers of expanded metal associated therewith. Each has predetermined apertures forming a reticulum.

According to another aspect of the present invention, the air ventilation system has a cartridge filter provided for each grease particle separator. The cartridge filter is disposed upstream thereof. Each cartridge filter and associated grease particle separator preferably forms an integral filtering unit.

According to another aspect of the present invention, the ventilation system allows for easy cleaning of the ventilation system and minimizes a down time of a food establishment associated with cleaning of the ventilation system, and allows a more continuous operation thereof.

According to still another aspect of the present invention, there is provided an air purifying device that has a structure having an air inlet for disposal over a source of contaminated grease laden air and an air outlet for discharging the air stream to ambient. The air inlet and the air outlet define a grease laden air flow. The air purifying device also has a device adjacent the air inlet with the device defining a compartment. The device is for reducing an amount of grease in the contaminated grease laden air stream and has a first member extending into the compartment. The grease laden air flow abruptly turns around the first member in the compartment and the grease laden air flow jettisons an amount of grease from the grease laden air flow after flowing past the first member and reduces a grease particle size of grease in the grease laden air flow. The device has sheets of material with each sheet having a number of apertures therethrough.

According to still a further aspect of the present invention, there is provided an air purifying device that has a ventilation structure with an air inlet for disposal over a source of contaminated grease laden air and an air outlet for discharging the air stream to ambient. The air inlet and the air outlet define a grease laden air flow. The device also has a grease removal device adjacent the air inlet with the grease removal device defining a compartment therein. The grease removal device is for reducing an amount of grease in the contaminated grease laden air stream and has a first member extending into the compartment. The grease laden air flow abruptly turns around the first member in the compartment and jettisons an amount of grease from the grease laden air flow after flowing past the first member. The grease removal device has a first sheet of material with a number of first apertures therethrough, and a second sheet of material spaced from the first sheet of material with the second sheet having a second apertures therethrough. The second sheet communicates with the ventilation structure. The first apertures are offset from the second apertures.

According to still yet another further aspect of the present invention, there is provided an air purifying device that has a structure with an air inlet for disposal over a source of contaminated grease laden air and an air outlet for discharging the air stream to ambient with the air inlet and air outlet defining a grease laden air flow. The air purifying device has another device being adjacent the air inlet with the device defining a compartment and having a first section for abruptly changing a direction of the grease laden air flow. The first section reduces an amount of grease from the grease laden air flow and the device has a second section. The second section changes the grease laden air flow from a laminar flow to a turbulent air flow. The second section further reduces the amount of grease.

According to still yet another further aspect of the present invention, there is provided an air purifying device that has a device for reducing an amount of grease in a grease laden air flow with the device adjacent an air inlet and the device defining a compartment. The device has a first section for abruptly changing a direction of the grease laden air flow with the change reducing the amount of said grease from the grease laden air flow. The device also has a second section for changing the grease laden air flow from a laminar flow to a turbulent air flow by passing the grease laden air flow through a net like structure. The second section further reduces the amount of the grease in the grease laden air stream. The air purifying device also has an ozone producing device on or in a ventilation structure in communication with the net like structure for reducing the amount of the grease from the grease laden air stream.

According to still yet another further aspect of the present invention, there is provided an air ventilation system. The air ventilation system has an ozone generating device between an air inlet of the ventilation system and an air outlet of the ventilation system. The system also has a first structure having a compartment at or adjacent the air inlet of the ventilation system. The first structure modulates an air flow at two places in the compartment for removal of a contaminant in the air flow.

### BRIEF DESCRIPTION OF THE FIGURES

Other and further objects, advantages and features of the present invention will be understood by reference to the following specification in conjunction with the accompanying figures, in which like reference characters denote like elements of structure and:

FIG. 1 is a perspective view of a ventilation system having an improved filter unit in accordance with the present invention;

FIG. 2 is a perspective view of a front side of the improved filter unit of FIG. 1 having an integrated cartridge filter and a grease particle separator in accordance with the present invention with a grease laden air stream entering the filter unit;

FIG. 3 is an exploded view of the integrated cartridge filter and grease particle separator of the filter unit of FIG. 2 in accordance with the present invention;

FIG. 4 is a rear view of the integrated cartridge filter and grease particle separator of the filter unit in accordance with the present invention;

FIG. 5 is a side view of the integrated cartridge filter and grease particle separator of the filter unit showing the grease laden air flow traversing therethrough in accordance with the present invention; and

FIG. 6 is a plan view of one preferred embodiment an expanded metal sheet of the grease particle separator of the filter unit of FIGS. 1 through 6 in accordance with the present invention.

### DESCRIPTION OF THE PREFERRED EMBODIMENT

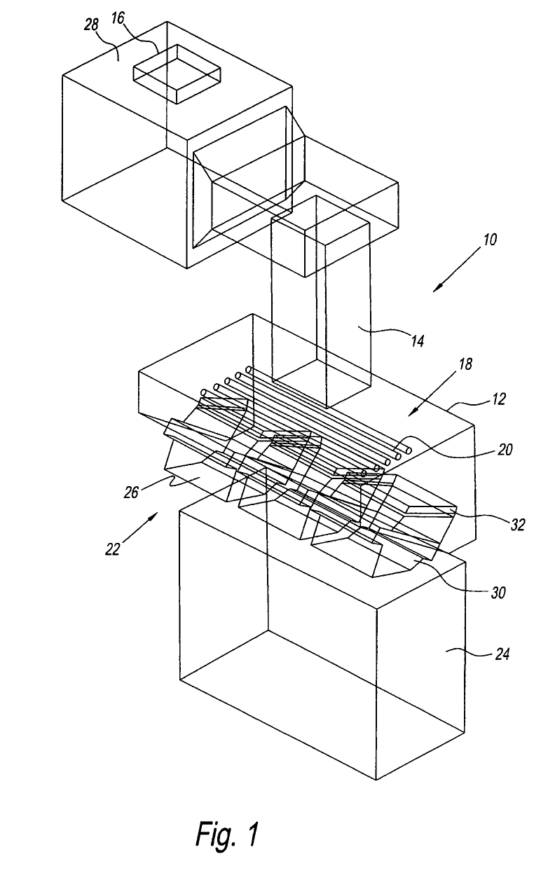

Referring to FIG. 1, there is shown a perspective schematic view of a preferred embodiment of an air purifying device 10 of the present invention, for use in commercial or home kitchens. In this embodiment, the air purifying device 10 generally has a hood 12, a ventilation duct 14, a fan 16, and a ultra-violet device 18 that has a number of UV lights 20, and a filter 22.

The filter 22 preferably has a number of unexpected benefits over the art and allows for relatively clean operation of the air purifying device 10, and reduces a risk of fire hazard while simultaneously allowing the air purifying device 10 to be used over a longer period of time without the costly and labor intensive cleaning that is known in the art. It has been observed that the filter 22 of the present invention preferably modulates a fluid flow of the contaminated air stream having at least grease and oil therein. This modulation is a change in a fluid flow of the air traversing therethrough from at least a laminar air flow to a turbulent air flow and allows for increased productivity of the air purifying device 10 and an overall reduced amount of grease in the grease laden air stream. The reduced amount of grease further allows for a more productive operation of the ultra-violet device 18 of the air purifying device 10. This operation allows for reduced labor costs and allows the commercial kitchen to be more productive, and aggregate less grease, and grease deposits. Instead the grease is allowed to pass through and be treated by the air purifying device 10.

The air purifying device 10 in one embodiment is a ventilation system for removing contaminated air from a commercial cooking establishment. However, one skilled in the art should appreciate that the air purifying device 10 is not limited to this configuration and may have any other known configurations and be used in other settings such as in a hospital, a health care center, a chemical facility, a secured facility, a correction facility or any other venue or location using or controlling contaminated air or gas, or air having oil, dirt, grease and organic and non-organic compounds.

The hood 12 of the air purifying device 10 or in one embodiment the ventilation system 10 is disposed at a certain convenient distance above a cooking appliance 24, such as a grill, an oven, a stove, a broiler, a deep fat fryer, a microwave oven, or any other cooking apparatus known in the art that emits a contaminated air stream. The ventilation system 10 has an air inlet 26. The air inlet 26 is for receiving a contaminated grease laden air stream and drawing the same into the air purifying device or ventilation system 10. The ventilation system 10 also has an outlet 28 on an opposite side for discharging the air stream that has been purified flowing through the ventilation system to the ambient. Preferably, the outlet 28 is a great distance away from the user.

The fan 16 is typically disposed adjacent the air outlet 28 of the ventilation duct 14 provided on, for example, a roof of the food establishment, or in any other suitable location depending in part on the local building rules. However, the present invention is in no way limited to this location.

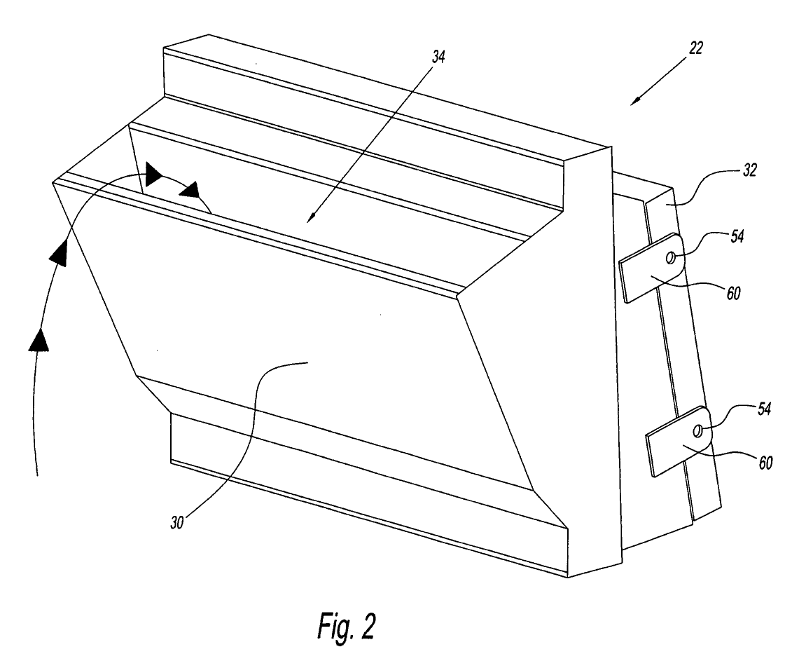

Referring now to FIG. 2, there is shown, the ventilation system 10 having the filter 22 in one embodiment being adjacent the air inlet 26 shown in FIG. 1. One skilled in the art should appreciate that the filter 22 is not limited to this location, and may be placed in other locations, or more than one, two or three filters may be placed at the inlet depending on the size of the ventilation unit 10.

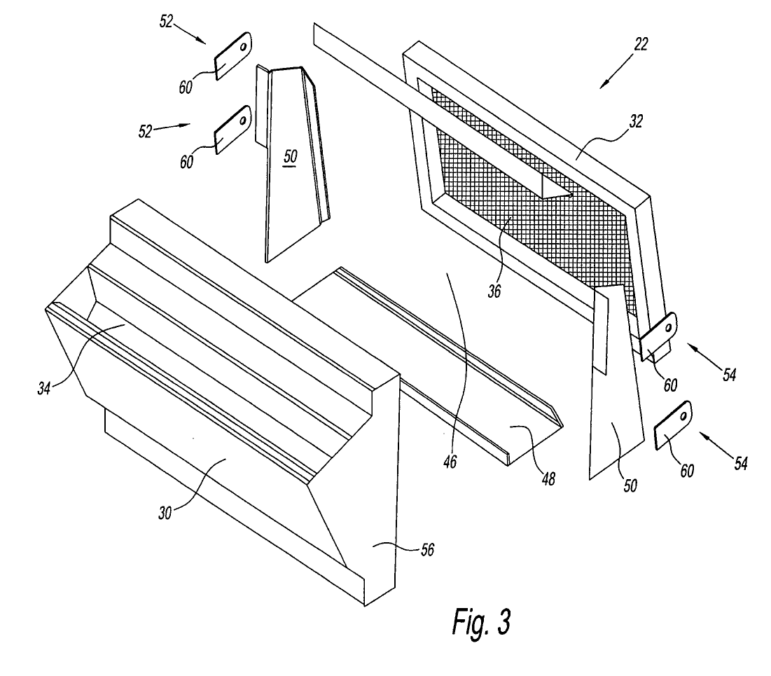

Referring now to FIGS. 2 and 3 showing an interior view of the filter 12, the filter has a cartridge filter 30 and a grease particle separator 32. In this embodiment, the cartridge filter 30 and the grease particle separator 32 are connected to one another so the cartridge filter 30 is on one side facing the cooking appliance 24 shown in FIG. 1 and the grease particle separator 32 is opposite the cooking appliance toward the ventilation duct 14. Both the cartridge filter 30 and the grease particle separator 32 form as an integral filter or filter generally represented as reference numeral 22.

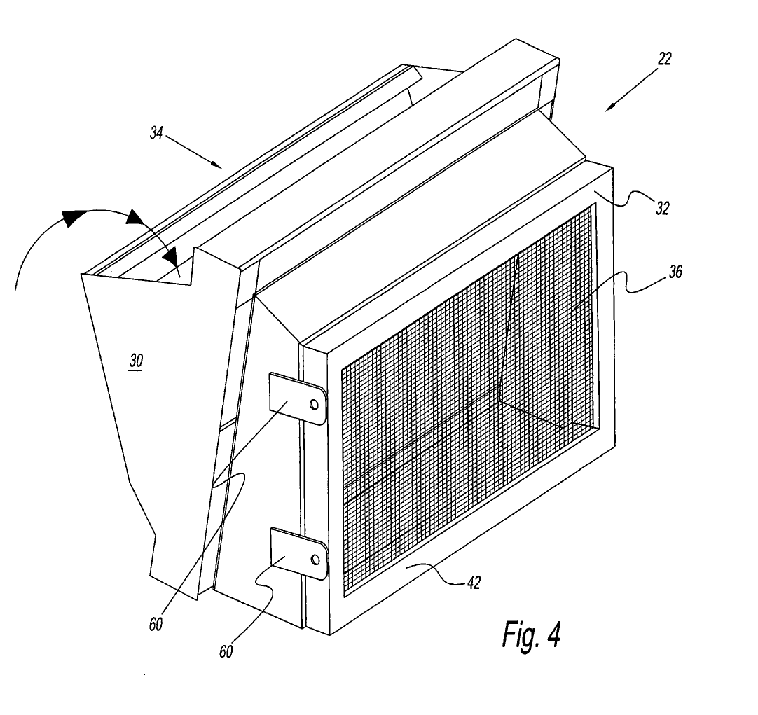

The cartridge filter 30 can be made of stainless steel, aluminum or other high temperature resistant materials that are not damaged by the heat associated with cooking well in excess of one hundred degrees Fahrenheit. Referring now to a rear view of the filter 22 shown in FIG. 4 and a front of the filter shown in FIG. 2, the filter preferably draws a contaminated air stream having contaminants, such as oil, grease and smoke into the cartridge filter 30 via the air inlet 34 thereof. One skilled in the art will appreciate that the air inlet 34 is disposed on a top side of the filter 22. This facilities with the removal of grease in the filter 22. Most preferably, the cartridge filter 30 preferably abruptly changes a direction of the contaminated air stream with the grease and the oil therein. Upon the abrupt change, larger grease particles will be jettisoned from the grease laden air stream and fall out of the air stream to be collected later. Most preferably, this results in the contaminated air stream having less grease upon exiting the cartridge filter 30 relative to entering the cartridge filter.

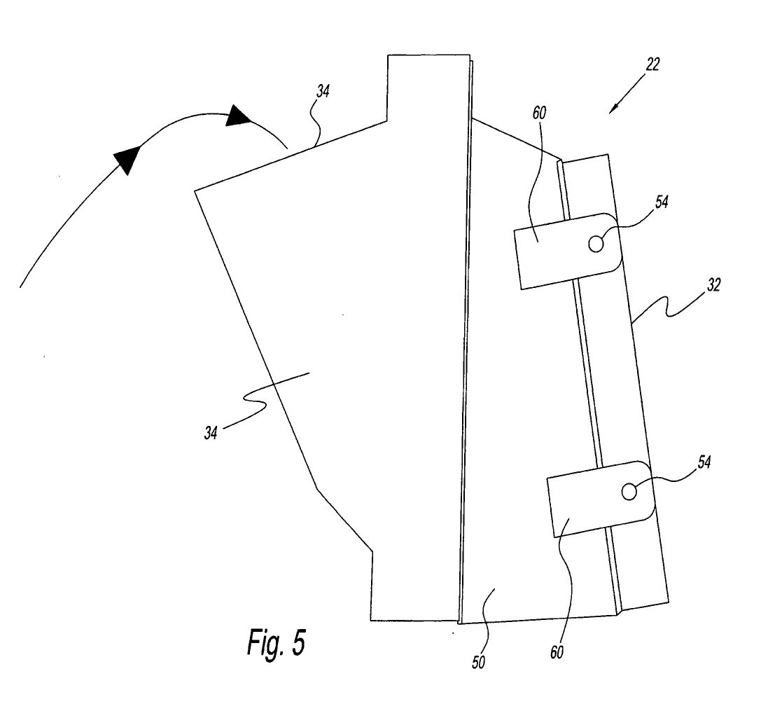

Once in the cartridge filter 30, substantially all of the relatively large grease and oil droplets pass along a path that is arcuate. The arcuate path allows the relatively heavier oil and grease particles to drop out of the air path and thus be captured therein and drain through one or more holes into a grease receptacle (not shown). Preferably, the grease receptacle is disposed below the cartridge filter 30 for easy of removal and the grease receptacle is well known in the art. Referring now to FIG. 5, the remaining relatively fine droplets of grease and oil that are not captured or that do not drop out of the path come into contact with the grease particle separator 32 that is disposed on the opposite side of the filter 22.

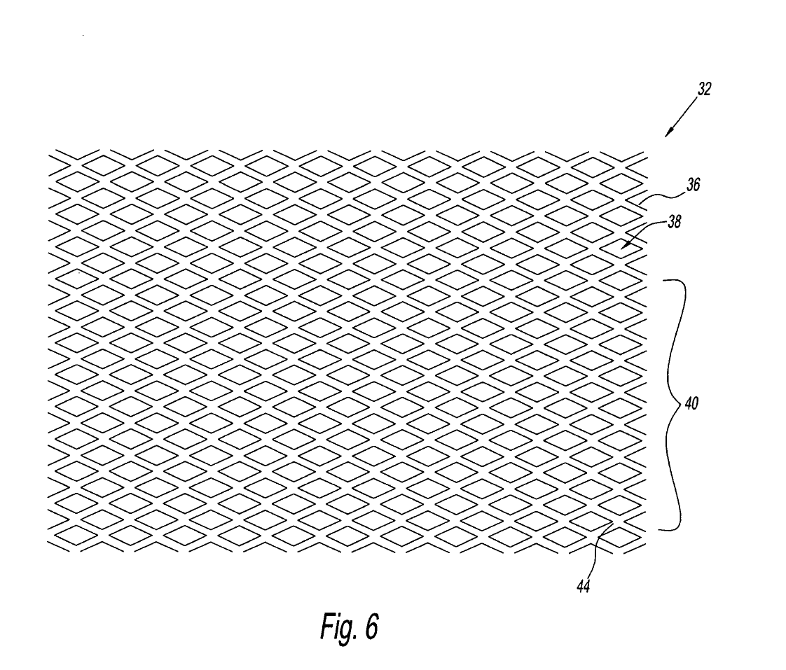

As can be seen in FIG. 6, the grease particle separator 32 has at least two layers of expanded metal 36. Preferably each of the two layers of metal 36 have a number of predetermined sized apertures 38 forming a reticulum formation 40. The reticulum formation 40 is preferably a netlike formation or structure or a network. The suitable materials include, but are not limited to, iron, stainless steel, chromium, yttrium, zirconium, aluminum or combination, mixture or alloy thereof. In one preferred embodiment, the aperture size is a 0.154 inch by 0.154 inch diamond shaped aperture. The sized aperture could be different depending on air flow, velocity, type of grease etc. The optimal size will differ for different conditions. Moreover, the size and shape of each aperture 38 on each sheet of expanded metal may be the same or different.

The apertures 38 can be of any shape known in the art and may be a diamond shape as shown in FIG. 6 or be rectangular, square, orthogonal, triangular or any other shape in the art. The at least two layers of expanded metal 36 are juxtaposed or stacked adjacent one another such that the apertures 38 of the two immediately adjacent layers of expanded metal reticulum are slightly offset from one another. The slightly offset configuration 38 is essential and thereby modulates a fluid flow of the grease laden air stream. The grease laden air fluid flow having the oil and grease therein will be changed. The grease laden air fluid flow will pass through one set of the expanded metal sheets 36 through the apertures 38 of a first layer. However, the apertures 38 of the second layer behind the first layer are offset from the apertures of the first layer. Thus, the filter 22 causes the grease and oil laden fluid flow to become turbulent and thus jettison further grease and oil prior to entering the ventilation duct 14. Thus, the apertures 38 of a first layer and the apertures of a second layer thereby form a netlike structure or labyrinthine flow path for air stream passing therethrough. In one preferred embodiment of the present invention, the two or more layers of expanded metal 36 may have no spacing therebetween. Less preferably, the two or more layers of expanded metal 36 may have a slight spacing therebetween.

The expanded metal or sheets 36 shown in FIG. 6 can be manufactured from any suitable temperature resistant material to reduce fire hazard, and most preferably are suitably rated and will pass any commercial cooking establishment building code standards. The suitable materials include, but are not limited to, iron, stainless steel, chromium, yttrium, zirconium, aluminum or combination, mixture or alloy thereof. As can be best seen in FIGS. 3 and 4, the expanded metal layers 36 or stack may be disposed inside a frame 42. The frame 42 preferably provides better support from the expanded metal and facilities the metal sheets being secured together.

The remaining finer droplets of grease and oil that have passed through the cartridge filter 30 contact the expanded metal layers 36 of the grease particle separator 32 and are deposited on a solid portion 44 of the expanded metal reticula shown in FIG. 6 while the reduced amount of grease in the grease laden air stream is allowed to pass or otherwise traverse therethrough to the duct 14. The fire hazard risk is fully minimized with the of expanded metal grease particle separator 32 of the present invention. Most preferably, the amount of grease in the grease laden air stream is modulated and an amount of the grease is reduced at two points in the filter 22 prior to the treatment of the grease laden air stream in the duct 14.

It has been observed that the air stream passing through the grease particle separator 32 has less contaminants relative to the instance without the filter 22. Referring again now to FIG. 1, the air stream enters the hood 12 and the ventilation duct 14. A number of first ultra-violet light bulbs 20 are disposed within the hood 12. The first UV light bulbs 20 preferably create ozone in the contaminated air stream. The ozone proceeds to oxidize organic contaminants in the air stream, including the grease and the oil. The UV radiation also breaks down large organic substances through the process of photolysis. These processes are particularly effective at removing odors from the air stream.

Most preferably, the cartridge filter 30 and the grease particle separator 32 form an integrated filter unit 22 that may be sold as one unit or otherwise installed and/or removed in one piece from the air purifying device 10. The integrated filter unit 22 is removably attached to the hood 12. The cartridge filter 30 has the air inlet 34 formed as a longitudinal slot. However, the air inlet 34 may also take the form of a lateral slot, a vertical slot, a series of baffles, one or more apertures and any combination thereof that allow the grease laden air stream to communicate with the ventilation system 10, and is not limited to any such configuration. The air inlet 34 preferably is of a suitable width and length to draw contaminated air therein. The air inlet 34 facilitates a laminar flow of the contaminated grease laden air stream in layers for entry into the cartridge filter 30.

A chamber 46 is preferably formed within and between the integrated cartridge filter 30 and the grease particle separator 32. The chamber 46 has a predetermined volume that allows an even distribution of air with remaining fine grease droplets to enter the grease particle separator 32. The grease droplets are intercepted by the expanded metal stacks 36 of the grease particle separator 32 and as mentioned above, drained down to a grease collector tray 48 provided at the bottom of the chamber 46. The grease collector tray 48 may be provided with optional holes to permit grease drain out of the integrated cartridge filter 30 and grease particle separator 32 via a hose (not shown) to an external container such as an oil drum. The collector tray 48 may be a substantially rectangular shaped member having a slight depth. However, it may take various shapes as can be appreciated by those skilled in the art, including but not limited to, U shape, V shape, etc. The collector tray 48 may further be provided with one or more optional channels (not shown) for facilitating collection and flow of the grease therein.

The grease particle separator 32 is disposed substantially at the rear most portion opposite the cartridge filter 30 of the filter 22 along the generally flow direction of the air stream. However, the grease particle separator 32 or additional grease particle separators 32 having two or more sheets 36 may be disposed at any desired location downstream of the cartridge filter 30. The grease particle separator 32 may preferably have an inclined upstream side or be disposed in an inclined position to promote collection of grease on a grease collector tray 48 at the bottom of the chamber 46.

The cartridge filter 30 is formed with one or more flat shaped lateral panel 50. The lateral panels 50 can be fixedly or removably connected to the cartridge filter 30 and the grease particle separator 32. The panels 50 define two lateral sides of the chamber 46 of the integrated filter 22 with the cartridge filter 30 and the grease particle separator 32, and aid with the fluid flow.

The grease particle separator 32 and the cartridge filter 30 are connected by suitable connectors. In this embodiment, two first lugs 52 and two second lugs 54 are respectively on two lateral sides 56 of the cartridge filter 30 and grease particle separator 32 through members 60. The connectors provide support to the grease particle separator 32 and maintains the grease particle separator 32 relative to the cartridge filter 30. The grease particle separator 32 can be detached from cartridge 30 and placed downstream the cartridge, anywhere between the cartridge and UV lights.

It can be appreciated that the connectors 52, 54 can also be provided on top, bottom sides of the integrated cartridge filter 30 and grease particle separator 32. The connectors 52, 54 may also be any suitable means that allows service personnel to removably open and close the integrated cartridge filter 30 and grease particle separator 32. Such connectors can include, but are not limited to, bolt, clamp, coupling, latch, snap fasteners, hooks, locks, lugs, nails, pins, a rivet and any optional combinations thereof.

When it is necessary to cleaning the integrated cartridge filter 30 and grease particle separator 32, the service personnel may only need to withdraw the dirty filter unit 22 from the hood 12 and replace the unit with a second fresh filter unit. This is particularly advantageous as this minimize the down time of the oven food establishment.

Referring again now to FIG. 1, two or more filters 22 can be removably connected to the hood 12. The number of the filters 22 can be determined according to parameters such as the volume, capacity, and flow rate of the ventilation system.

It is to be appreciated that the ultra-violet lights 20 can be disposed in other space or chambers within the ventilation system 10 as known to those skilled in the art, depending on the configuration of the hood 12 and/or ventilation duct 14 of the ventilation system in a particular application. Specifically, the ultra-violet lights 20 can be disposed in a stand-alone hood 12. Alternatively, it can be disposed in a retro-fit unit to be added to an existing ventilation system 10. Likewise, the filter 22 may also be incorporated in a stand-alone ventilation hood or a retro-fit unit.

The present invention having been thus described with particular reference to the preferred forms thereof, it will be obvious that various changes and modifications may be made therein without departing from the spirit and scope of the present invention as defined in the appended claims.

1-22. (canceled)

23. A fume treatment apparatus for kitchen exhaust fumes, comprising:
a filter module with an inlet having an inlet for positioning over a source of fumes and an outlet;
a first grease filter configured to remove a fraction of grease particles in the fumes positioned at the inlet and a second grease filter configured to remove a further fraction of grease particles, the filter module being configured such that a chamber is defined between the first and second grease filters, thereby forming an integral structure;
the first grease filter being configured to remove smaller particles remaining in the fumes after filtering by the first grease filter;
the second grease filter having multiple adjacent sheets each having holes arranged such that holes in adjacent sheets are offset to form a reticulum, the adjacent sheets being spaced apart;
the second grease filter being removably attached to the filter module;
an exhaust hood having a plurality of ultraviolet lamps positioned in a flow path;
the exhaust hood being configured to removably receive the filter module such that the chamber is in fluid communication, through the second grease filter, with the flow path and such that the ultraviolet lamps are adjacent the second grease filter.

24. Apparatus as in claim 23, wherein the filter module includes a tray configured to convey grease from the first and second filters.

25. Apparatus as in claim 23, wherein the first filter is a cartridge type filter with baffles.

26. Apparatus as in claim 23, wherein the holes are approximately 0.15 inch in size.

27. Apparatus as in claim 23, wherein the sheets are expanded sheet metal.

28. A fume treatment apparatus for kitchen exhaust fumes, comprising:
an exhaust apparatus with a hood and ultraviolet lamps positioned in a flow path thereof;
a filter module with first and second grease filters;
the first grease filter configured to remove a fraction of grease particles in the fumes positioned at the inlet and a second grease filter configured to remove a further fraction of grease particles;
the second grease filter having a smaller aperture size than the first grease filter such that the first grease filter is configured to remove smaller particles remaining in the fumes after filtering by the first grease filter;
the second grease filter having multiple adjacent sheets each having holes arranged such that holes in adjacent sheets are offset to form a reticulum, the adjacent sheets being spaced apart;
the exhaust hood being configured to removably receive the filter module such that the chamber is in fluid communication, through the second grease filter, with the flow path and such that the ultraviolet lamps are adjacent the second grease filter.

29. Apparatus as in claim 28, wherein the filter module includes a tray configured to convey grease from the first and second filters.

30. Apparatus as in claim 28, wherein the first filter is a cartridge type filter with baffles.

31. Apparatus as in claim 28, wherein the holes are approximately 0.15 inch in size.
